(19) United States
(12) Patent Application Publication
(10) Pub. No.: US 2009/0186492 A1
(43) Pub. Date: Jul. 23, 2009

(54) ROTATABLE ELECTRICAL PLUG CONNECTOR

(76) Inventors: Yue Xue Xia, Singapore (SG); Mui Lian Jessica Toh, Singapore (SG); Chee Foo Richard Loh, Singapore (SG)

Correspondence Address: OCCHIUTI ROHLICEK & TSAO, LLP, 10 FAWCETT STREET, CAMBRIDGE, MA, 02138, US

(21) Appl. No.: 12/296,374

(22) PCT Filed: May 24, 2007
(86) PCT No.: PCT/SG07/00149

§ 371 Date: Dec. 5, 2008

Related U.S. Application Data
(60) Provisional application No. 60/846,358, filed on Sep. 22, 2006.

(51) Int. Cl. H01R 39/00

(52) U.S. Cl. 439/18

(57) ABSTRACT

A rotatable electrical plug connector includes a main body and an auxiliary plug which is rotatably coupled to the main body. The main body is provided with fixed electrical terminals, the auxiliary plug is provided with electrical blades, and the rotatable electrical plug connector has electrical connection members connecting the electrical terminals and the electrical blades. The auxiliary plug is io rotatable relative to the main body, and may be fixed to the main body at any predetermined position. At each predetermined position and during rotation of the auxiliary plug, the electrical blades and the electrical terminals are electrically connected at all times. A rotatable electrical plug connector according to embodiments of the present invention is suitable to connect to power supply is sockets at convenient engagement positions.

### TECHNICAL FIELD

The present invention relates to an electrical power connector. In particular, it relates to a rotatable electrical plug connector.

### BACKGROUND OF THE INVENTION

Electrical plug connectors are used in electrical devices where external power supply is required. Conventional electrical plug connector has electrically conductive blades connected to a power cable and fixed together in a housing. When in use, the plug connector is plugged into a power supply socket, for example a wall power outlet through which, electricity can be supplied to the electrical device connected by the power cable.

Users often encounter difficulties when using the conventional electrical plug connectors, in particular when the access to wall power outlet is constraint due to limited space available, or the blockage by surrounding items such as furniture or other power cables. In such situations, in order to connect to the wall power outlet, the power cable may have to be routed around the blockage or, if not long enough, the power cable may be forced to bent to accommodate the constraint access space. This may cause poor connections to the power socket, hence the plug connector may tend to loose or disengage from the power socket, and result in power supply failure.

It is therefore desirable to provide an improved electrical plug connector which enables users to select a suitable and convenient angle of engagement with the wall power sockets, depending on the conditions of the surrounding items and space available. Unfortunately, such an electrical plug connector is currently not available.

### SUMMARY OF THE INVENTION

A rotatable electrical plug connector according to embodiments of the present invention has a main body and an auxiliary plug. A first set of electrical blades is fixed to the auxiliary plug and a second set of electrical terminals is fixed to the main body.

The auxiliary plug is rotatably coupled to the main body by a pivot shaft which is electrically connected to the second set of electrical terminals.

The rotatable electrical plug connector includes connection members for electrically coupling to the first set of electrical blades and second set of electrical terminals.

The connection members are spring contact by a spring bush to the pivot shaft such that during rotation of the auxiliary plug, the first set of electrical blades and the second set of electrical terminals are electrically connected at all times and at any position.

The connection members are in contact with the side surface of the pivot shaft to provide a primary electrical connection. The connection members may also in contact with the end surface of the pivot shaft to provide a complementary electrical connection.

The rotatable electrical plug connector further includes resilient members biased to the auxiliary plug for fixing the auxiliary plug at desired positions, and to enable releasably flip of the auxiliary plug to rotate relative to the main body, and to one or other pre-determined positions.

A rotatable electrical plug connector according to embodiments of the present invention is suitable to connect to power supply sockets at convenient engagement positions. Routing or force bending of the power cable due to space constraint may be avoided. Access to power supply socket is more convenient, and power supply reliability is improved.

### BRIEF DESCRIPTION OF THE DRAWINGS

These and other aspects and advantages of the present invention will be described in detail with reference to the accompanying drawings, in which:

FIG. 1A is a perspective view showing a rotatable electrical plug connector according to one embodiment of the present invention, when the electrical blades are rotated facing outward;

FIG. 1B is a perspective view of FIG. 1A when the electrical blades are rotated facing upward;

FIG. 1C is a perspective view of FIG. 1A when the electrical blades are rotated facing downward;

FIG. 1D is a perspective view of FIG. 1A when the electrical blades are rotated facing inward;

FIG. 2A is a partial perspective showing an internal structure of a rotatable electrical plug connector of FIG. 1A;

FIG. 2B is a partial perspective showing an internal structure of a rotatable electrical plug connector of FIG. 1B;

FIG. 2C is a partial perspective showing an internal structure of a rotatable electrical plug connector of FIG. 1C;

FIG. 2D is a partial perspective showing an internal structure of a rotatable electrical plug connector of FIG. 1D;

FIG. 3A is a perspective view showing an electrical blade of a rotatable electrical plug connector of FIG. 1A;

FIG. 3B is a perspective view showing two electrical blades integrated together to form an auxiliary body of the rotatable electrical plug connector shown in FIG. 1A;

FIG. 3C is an exploded perspective view showing a position of the auxiliary body of the rotatable electrical plug connector;

FIG. 3D is a perspective view of FIG. 3C when assembled together;

FIG. 3E is a perspective view of FIG. 3D with a spring member is assembled to the auxiliary plug;

FIG. 4A is an exploded perspective showing electrical connection members and the auxiliary plug;

FIG. 4B is a perspective view of a first electrical connection member of the rotatable electrical plug connector;

FIG. 4C is a perspective view of a second electrical connection member of the rotatable electrical plug connector;

FIG. 4D is a partially enlarged view of FIG. 4C;

FIG. 4E is a front view showing a connection structure of the auxiliary body and an electrical connection member;

FIG. 4F is a A-A cross sectional view of FIG. 4E;

FIG. 5A is a perspective view of FIG. 4A when the electrical connection members are assembled to the auxiliary plug;

FIG. 5B is a perspective view of FIG. 5A from another viewing point;

FIG. 6A is a perspective view of a top cover of a rotatable electrical plug connector shown in FIG. 1B;

FIG. 6B is a perspective of the auxiliary body and electrical connection members of the rotatable electrical plug connector shown in FIG. 1B;

FIG. 6C is a perspective of the base member of the rotatable electrical plug connector shown in FIG. 1B;

FIG. 7 is a perspective view of a rotatable electrical plug connector when the parts showing in FIGS. 6A, 6B and 6C are assembled together.

### DETAILED DESCRIPTION OF THE PREFERRED EMBODIMENTS

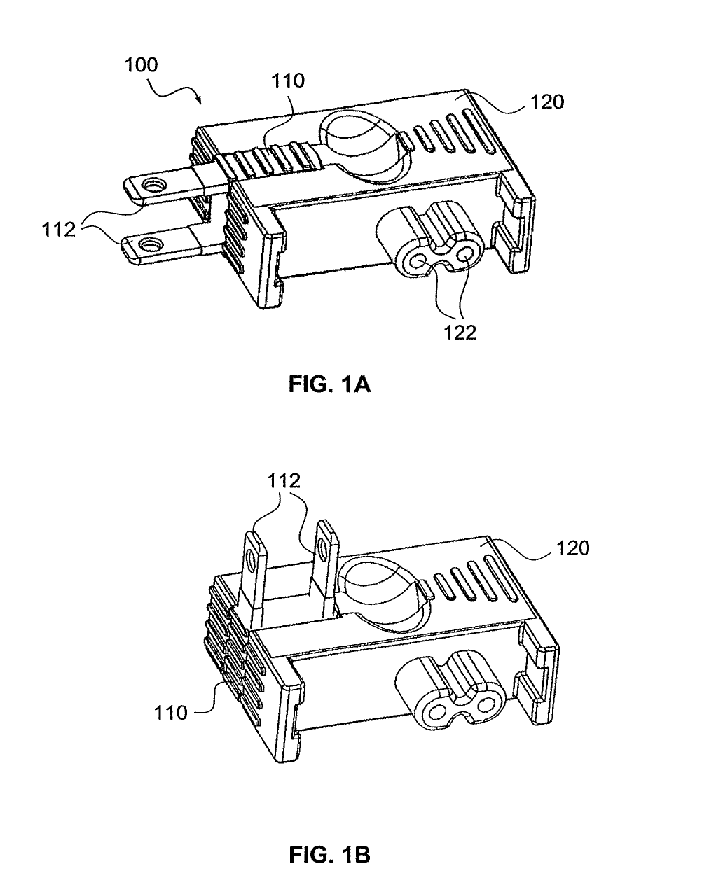

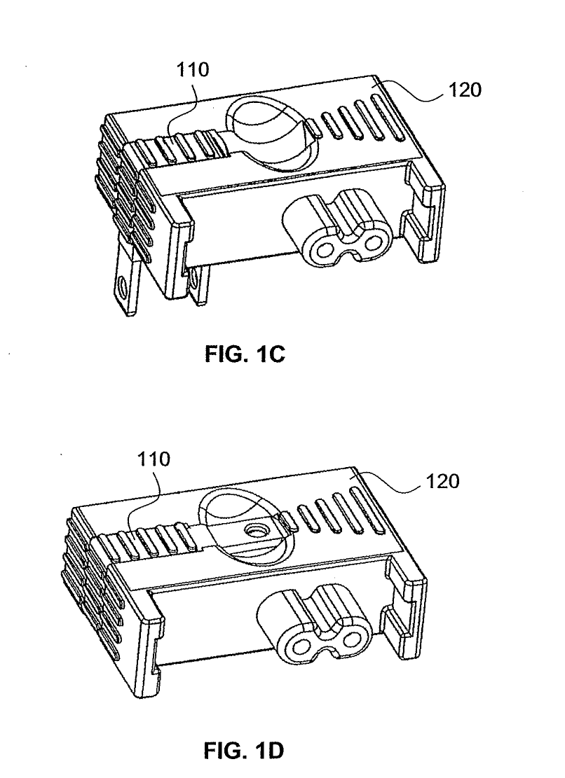

As shown in FIGS. 1A, 1B, 1C and 1D, a rotatable electrical plug connector 100 according to one embodiment of the present invention has a main body 120 and an auxiliary plug 110. A set of electrical blades 112 is fixed to the auxiliary plug 110, and a set of electrical terminals 122 is fixed to the main body 120. the electrical blades and the electrical terminals may be made of electrically conductive material, such as brass. The set of electrical terminals 122 may be configured according to industrial standards, for connecting to another electrical device for supplying electrical power thereto. The auxiliary plug 110 is rotatably coupled to the main body 120, and is rotatable relative to the main body at different positions.

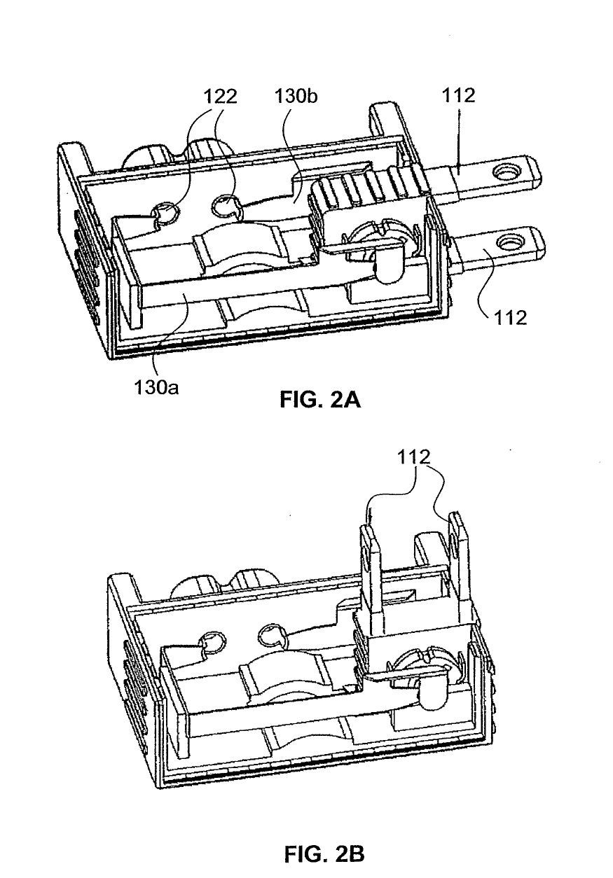

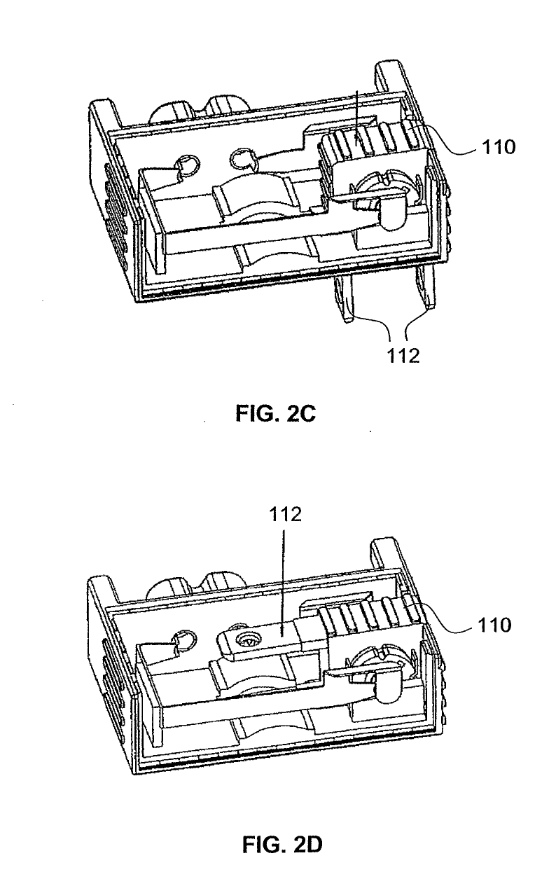

As shown in FIGS. 2A, 2B, 2C and 2D, the rotatable electrical plug connector 100 includes connection members 130a and 130b for electrically coupling to the set of electrical blades 112 and set of electrical terminals 122.

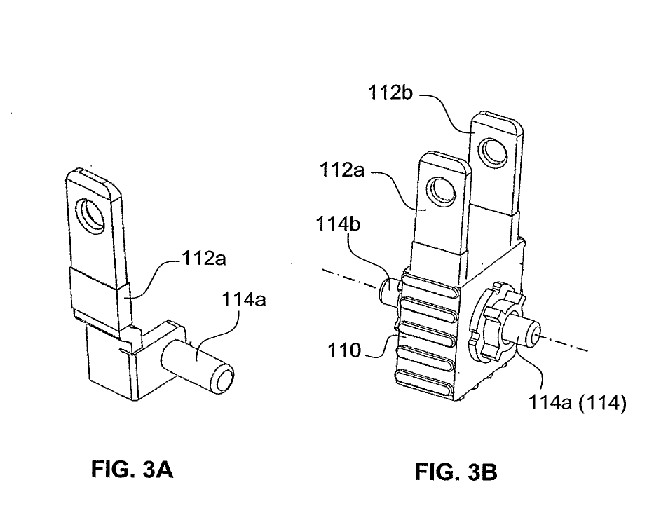

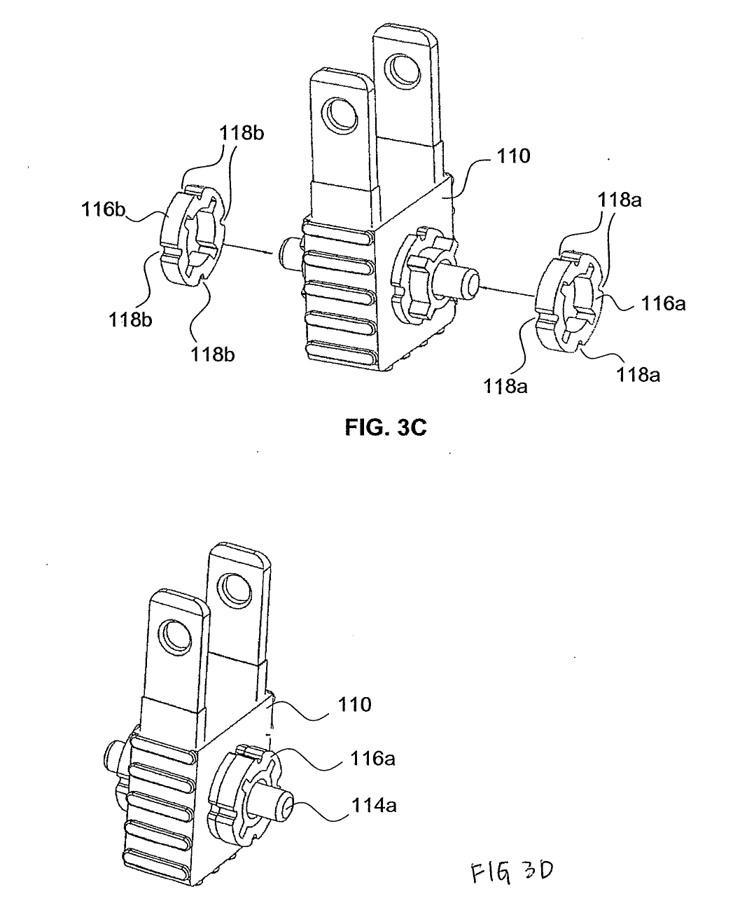

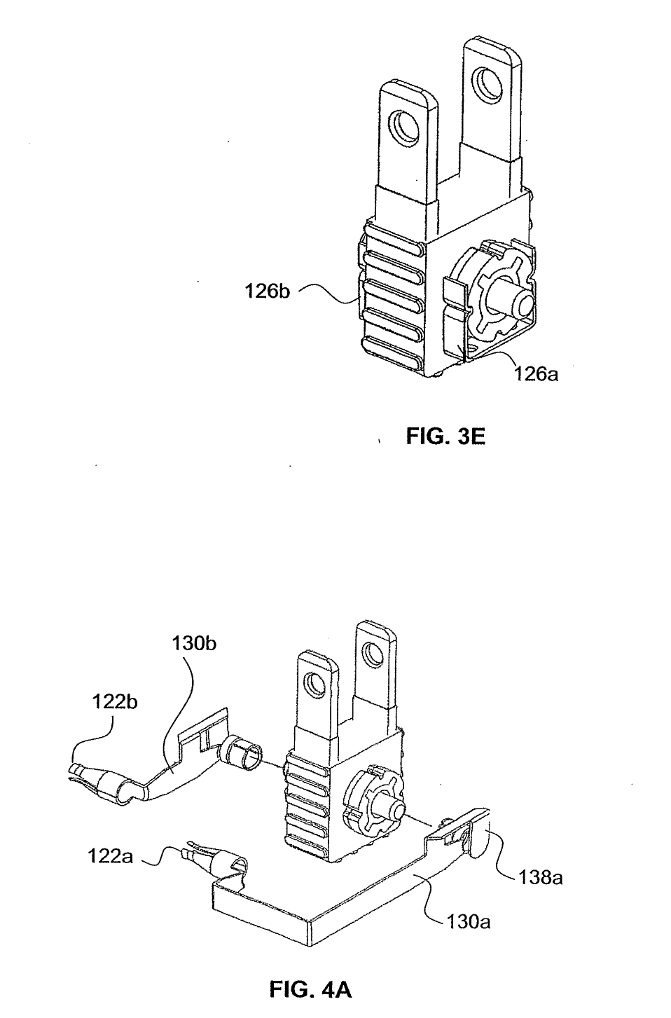

One of the set of electrical blades 112, referred to as blade 112a, is shown in FIG. 3A. A shaft member 114a is formed at one end of electrical blade 112a. Preferably, electrical blade 112a and shaft member 114a are formed of one piece of electrical conductive material, for example, brass. In the present embodiment, the other one of the set of electrical blades 112, referred to as electrical blade 112b in FIG. 3B, has a same shape, dimension and material as electrical blade 112a. Electrical blades 112a and 112b may be fixed together by, for example, molding, with an insulating material forming the auxiliary plug 110, as shown in FIG. 3B.

Electrical blades 112a and 112b are fixed together in such a configuration that, blades 112a and 112b are positioned in a blade plane and parallel to each other forming an electrical power plug conforming to industrial standards. Shaft members 114a and 114b are axially aligned with each other, forming a pivot shaft 114 on the auxiliary plug 110. In the present embodiment, pivot shaft 114 is positioned orthogonal to the blade plane.

As shown in FIGS. 3C, 3D and 3E, a pair of notched rings 116a and 116b are installed onto the auxiliary body 110, each having four notches 118a and 118b formed thereon. Notched rings 116a and 116b will be fixed to and rotate together with, the auxiliary body 110. A pair of springs 126a and 126b is biased on respective notched rings 116a and 116b. Detailed structures and functions of the springs 126a and 126b will be described below.

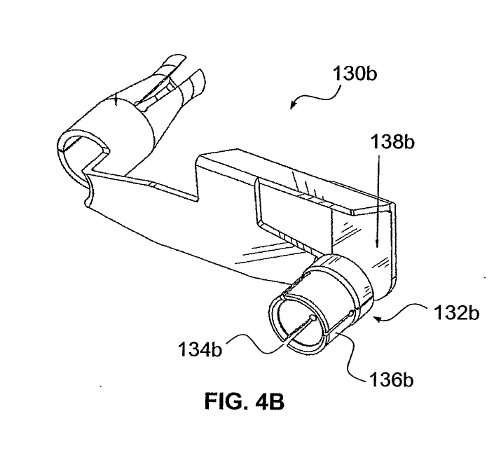

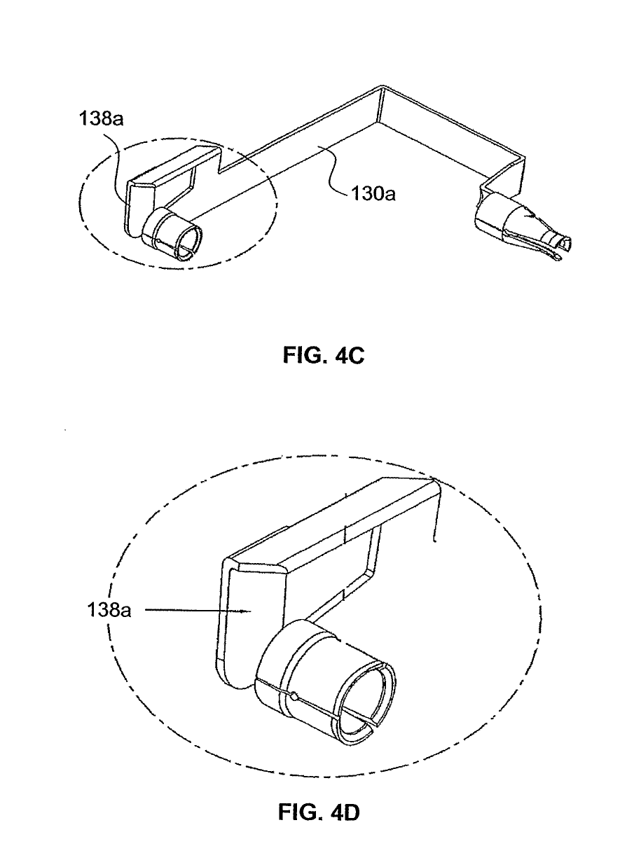

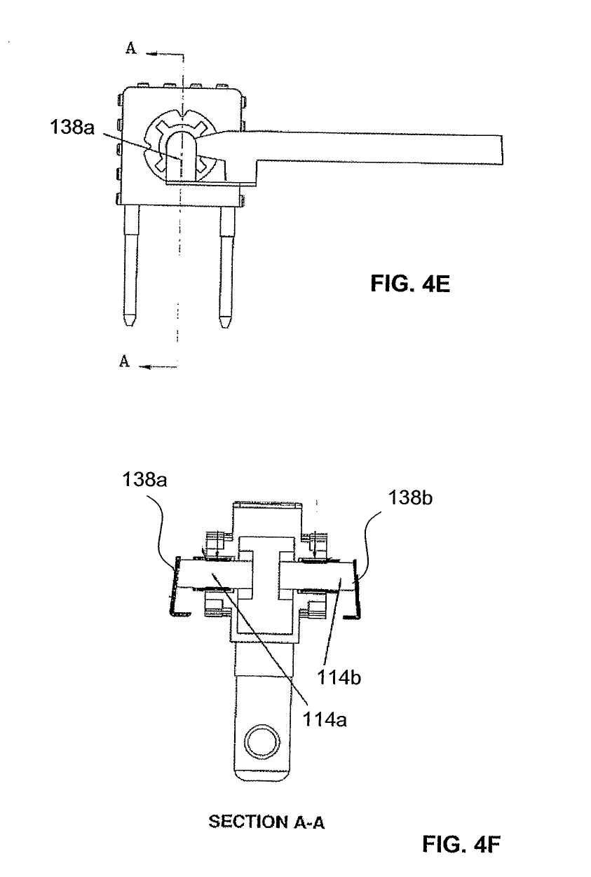

As shown in FIG. 4A, electrical connecting members 130a and 130b are provided, each for electrically connecting one electrical blade 112a or 112b to a corresponding electrical terminal 122a or 122b. One of the connecting members, e.g. connecting member 130b is taken as an example to illustrate its detailed structures and positional relationship with the auxiliary plug 110, as shown in FIG. 4B,

Formed at one end of the connecting member 130b there is a spring bush 132b, having a bore dimension slightly smaller than the diameter of the shaft 114.

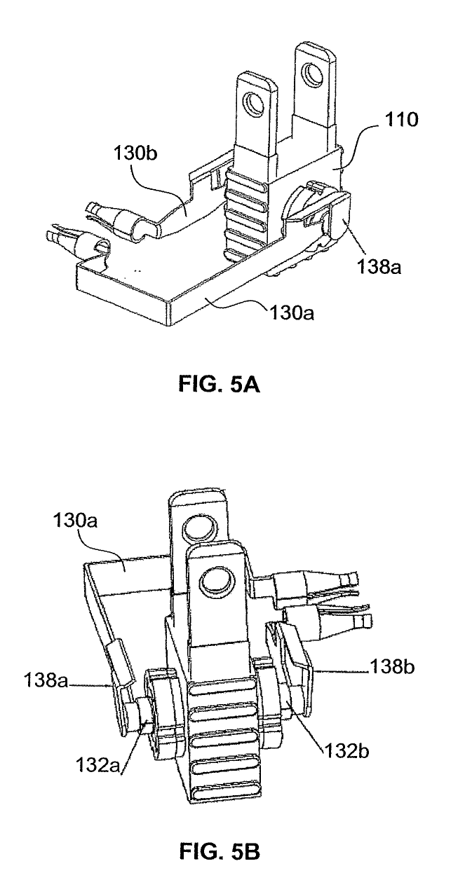

As shown in further details in FIGS. 4B, 4C, 4D, 4E and 4F, spring bush 132b has a number of slits 134b formed on the sidewall 136b. The spring bush 132b is therefore divided by slits 134b into several segments along the circular direction of the spring bush 132b. Connecting member 130b and spring bush 132b are formed of electrically conductive and resilient material, for example alloy, such that the pivot shaft 114 can be inserted into the spring bush 132b, by overcoming the spring force of the spring bush 132b. When the pivot shaft 114 is inserted, the spring bush 132b is slightly deformed outwardly, resulting in a resilient force in the spring bush 132b. By this arrangement, the pivot shaft 114 is maintained with good contact with spring push 132b, hence the connecting member 130b. The other one of the connecting member 130a is structured and installed onto pivot shaft 114 in a similar manner, as shown in FIGS. 5A and 5B. When the auxiliary plug 110 is installed on connecting members 130a and 130b, spring bushes 132a and 132b also serve as a bearing to support the auxiliary plug 110 such that, the auxiliary plug 110 becomes rotatable relative to the connection members 130a and 130b. Due to the spring force of the spring bushes 132a and 132b exerted onto the pivot shaft 114, the pivot shaft 114 is in electrical contact with the connecting members 130a and 130b, along the side surface of the pivot shaft 114 to provide a primary electrical connection, at any rotational position of the auxiliary plug 110. Accordingly, electrical blades 112 are electrically connected to connecting members 130a and 130b, during rotation of the auxiliary plug 110 at any position.

According to another embodiment, each of the connecting members 130a and 130b is further provided with a spring leaf 138a and 138b, as shown in FIGS. 4A to 4F. When the pivot shaft 114 is inserted into the spring bush 132a and 132b, spring leaf 138a and 138b bias against an end surface of the pivot shaft 114, providing a complementary electrical connection between the connecting members 130a, 130b and the pivot shaft 114. Spring leaves 138a and 138b therefore increase the reliability of the electrical contact between the electrical connection members and the shaft.

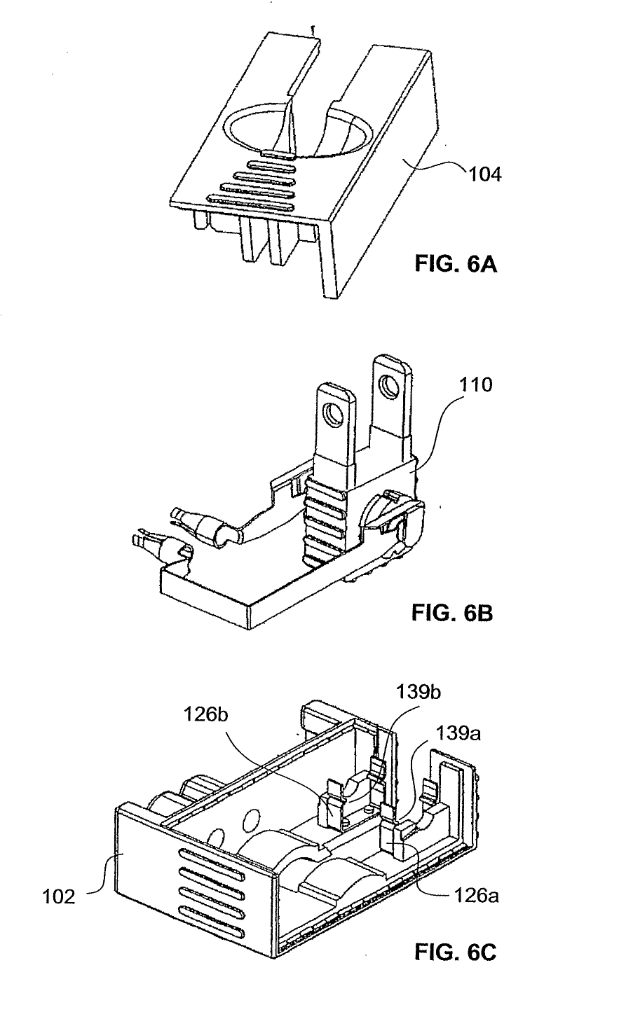

As shown in FIGS. 6A, 6B and 6C, the auxiliary plug 110, assembled with the electrical connection members 130a and 130b can now be installed onto base 102 of the main body 120.

As mentioned above, the springs 126a and 126b are fixed to base 102. When the auxiliary plug 110 is installed onto the base 102, springs 126a and 126b act against notched rings 116a and 116b, respectively, and with the tip 139a and 139b engaged with one of the notches. By virtue of this arrangement, auxiliary plug 110 is prevented from free rotation, but can only be rotated by overcoming the spring force exerted by springs 126a and 126b, typically through an action of a user.

In one embodiment, four notches are provided in each of the notched rings by which, the auxiliary plug 110 can be fixed at 0°, 90°, 180°0 and 270° positions relative to the main body 120. It should be appreciated that notches other than four may be formed as alternatives, for example, 3, 5, 6 or other numbers, and with fixing angled other than 0°, 90°, 180° and 270°.

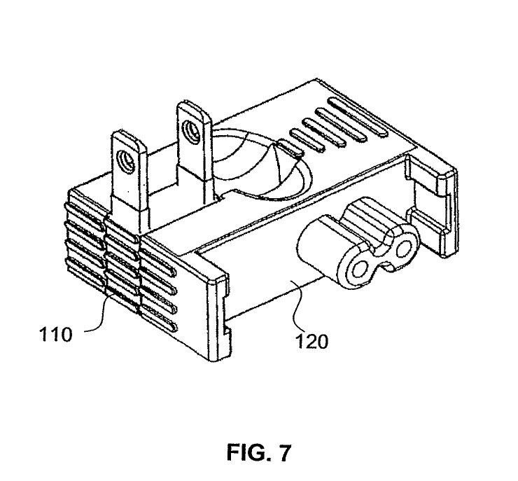

The auxiliary plug 110 is installed onto base 102, after the electrical connection member 130b is fixed to the auxiliary plug 110. The other electrical connection member 130a is then fixed to the base 102 and assembled with the auxiliary plug 110. Thereafter, the top cover 104 is capped to the base 102 to form the rotational electrical plug connector 100, as shown in FIG. 7.

Although embodiments of the present invention have been illustrated in conjunction with the accompanying drawings and described in the foregoing detailed description, it should be appreciated that the invention is not limited to the embodiments disclosed, and is capable of numerous rearrangements, modifications, alternatives and substitutions without departing from the spirit of the invention as set forth and recited by the following claims.

1. An electrical connector comprising:
a main body having a set of electrical terminals formed thereon;
an auxiliary plug rotatably coupled to the main body, and having a set of electrical blades formed thereon;
electrical connection members disposed in the main body, and coupled to the electrical terminals and the electrical blades;
wherein the auxiliary plug is rotatable relative to the main body while maintaining electrical connections between the electrical terminals and the electrical blades.

2. The electrical connector as recited in claim 1, wherein the auxiliary plug has a pair of projections forming a pivot shaft thereon, and wherein the auxiliary plug is rotatably coupled to the main body by the pivot shaft.

3. The electrical connector as recited in claim 2, wherein the pair of projections is electrically insulated from each other, and each one of the pair of projections is electrically connected to one of the set of electrical blades.

4. The electrical connector as recited in claim 3, wherein each of the electrical connection members is to engage with a side surface of one of the pair of projections to form a first electrical connection therebetween.

5. The electrical connector as recited in claim 4, wherein each of the electrical connection members has a sleeve portion to engage with the side surface of one of the pair of projections.

6. The electrical connector as recited in claim 5, wherein the sleeve portion forms a bush to support the pivot shaft.

7. The electrical connector as recited in claim 5, wherein the sleeve portion has slits partially separating the sleeve into two or more segments along a circular direction, wherein the two or more segments are biased against the side surface of the corresponding projection.

8. The electrical connector as recited in claim 3, wherein each of the electrical connection members is to engage with an end surface of one of the pair of projections to form a second electrical connection therebetween.

9. The electrical connector as recited in claim 8, wherein each of the electrical connection members has a spring leaf to engage with the end surface of one of the pair of projections.

10. The electrical connector as recited in claim 2, wherein the set of electrical blades are disposed in a blade plane and the pivot shaft is orthogonal to the blade plane.

11. The electrical connector as recited in claim 1, wherein the auxiliary plug is fixable to the main body at a predetermined position.

12. The electrical connector as recited in claim 11, further comprising a resilient member biased against the auxiliary plug for fixing the auxiliary plug at the predetermined position.

13. The electrical connector as recited in claim 12, wherein the auxiliary plug comprises a recess for engaging with the resilient member at which the auxiliary plug is locked at the predetermined position.

14. The electrical connector as recited in claim 13, wherein the auxiliary plug further comprises a plurality of recesses each for engaging with the resilient member at which the auxiliary plug is locked to the main body at a corresponding one of the plurality of predetermined positions.

15. The electrical connector as recited in claim 14, wherein when the auxiliary plug is locked to a first one of the plurality of predetermined positions, the set of electrical blades is received within the main body.

16. The electrical connector as recited in claim 14, wherein when the auxiliary plug is locked to a second one of the plurality of predetermined positions, the set of electrical blades is along a first angled direction perpendicular to a main plane of the main body.

17. The electrical connector as recited in claim 14, wherein when the auxiliary plug is locked to a third one of the plurality of predetermined positions, the set of electrical blades is parallel to a main plane of the main body.

18. The electrical connector as recited in claim 14, wherein when the auxiliary plug is locked to a fourth one of the plurality of predetermined positions, the set of electrical blades is along a second angled direction opposite to the first angled direction.

19. The electrical connector as recited in claim 1, wherein the auxiliary plug is disposed within the main body.
